(19) United States
(12) Patent Application Publication
(10) Pub. No.: US 2015/0034136 A1
(43) Pub. Date: Feb. 5, 2015

(54) Cleaning Tool for Use in Boreholes and Pipes

(71) Applicant: Algard CNC AS, Algard (NO)

(72) Inventors: Stig Bakke, Algard (NO); Rune Fjetland, Bjerkreim (NO)

(21) Appl. No.: 14/131,865

(22) PCT Filed: Jul. 4, 2012
(86) PCT No.: PCT/NO2012/050130

§ 371 Date: Mar. 6, 2014

(30) Foreign Application Priority Data
Jul. 20, 2011 (NO) 20111041

(51) Int. Cl. B08B 9/032

(52) U.S. Cl. CPC B08B 9/0321
USPC 134/167 C

(57) ABSTRACT

A cleaning tool is for use in boreholes and pipes. The cleaning tool includes a stator and a rotor which is rotatable around the stator. At least one rotor opening is arranged in the rotor for liquid flow. A stator sector angle is between adjacent stator openings and is different from a rotor sector angle between adjacent rotor openings.

This invention relates to a cleaning tool. More particularly, it relates to a cleaning tool for use in boreholes and pipes, the cleaning tool including a stator and a rotor which is rotatable around the stator, and there being at least one opening arranged in the rotor for liquid flow.

It is common to clean boreholes and pipes by pumping liquid at a relatively high flow rate down a pipe in the borehole and out towards, for example, a pipe wall via a static or rotating nozzle. It is necessary to use quite a high flow rate to ensure a cleaning effect and the lifting capacity necessary to carry waste out of the borehole during and after cleaning.

It is well known that rotating nozzles provide efficient cleaning, but also that a central current problem with rotating nozzles is that the rotational speed of the nozzle increases with the flow rate until it becomes so high that the nozzle is no longer effective.

It is known to brake the rotational speed of a rotating nozzle. U.S. Pat. No. 5,909,848 thus discloses a high-pressure washing nozzle with a relatively complicated brake activated by a coil spring. By braking the rotational speed, an improved cleaning effect will be achieved. It is vital that the rotational speed is braked without reducing the liquid flow to a substantial degree as this will affect the ability to lift undesired material out of the well.

U.S. Pat. No. 5,195,585 and WO 99/54590 both show examples of rotating nozzles, wherein the nozzles are arranged in a cylinder-shaped rotor sleeve surrounding a stator, but without an effective rotation brake.

The invention has for its object to remedy or reduce at least one of the drawbacks of the prior art.

The object is achieved, according to the invention, through the features which are specified in the description below and the claims that follow.

A cleaning tool for use in boreholes and pipes is provided, the cleaning tool including a stator and a rotor which is rotatable around the stator, and there being at least one rotor opening arranged in the rotor for liquid flow, and the cleaning tool being characterized by a stator sector angle between adjacent stator openings being different from a rotor sector angle between adjacent rotor openings.

Thereby, the stator and the rotor normally have different numbers of, respectively, stator openings and rotor openings or axial sets of rotor openings for liquid flow distributed around their circumferences.

When the rotor rotates around the stator, only a portion of the rotor openings will correspond with stator openings. New rotor openings are brought approximately continuously to correspond with the stator openings, and an adjacent rotor opening, relative to the active rotor opening, is normally activated first.

Such alternate activation and deactivation of rotor openings results in the fact that, during operation, the rotor may be radially displaced, rotating eccentrically relative to the stator. Activation means that the supply to the relevant rotor opening is opened, whereas deactivation means that the supply to the rotor opening is shut off, at least in the main.

It has surprisingly turned out that a cylindrical rotor which is rotating somewhat eccentrically relative to the cylindrical stator increases its rotational speed with increasing flow rate, after which the speed remains approximately constant even if the amount of liquid increases further.

It is assumed that the reason for this favourable effect is that, during operation, the rotor rests against the stator in a position following the rotor opening activated at any time and is braked mechanically. It is also assumed that the viscosity of the liquid affects the braking, but the condition has not been studied yet.

The rotor openings of the rotor may have a radial resultant angle which is different from zero regardless of what position the rotor has relative to the stator. This means that the sum of the angles between the centre line of each active rotor opening and the radial axis of the rotor through the rotor opening is different from zero, which has the effect of the reactive force from the liquid flowing through the rotor openings giving the rotor a torque for start and operation.

The rotor may have rotor openings that are directed at an angle relative to the longitudinal axis of the cleaning tool. A rotor opening may thus he arranged in such a way that the centre axis of the opening has an angular deviation in both the radial and axial directions relative to the radial axis of the rotor through the rotor opening.

The device in accordance with the invention solves a long-felt problem of a desired flow rate for conveying loosened mass out of the borehole or pipe being difficult to achieve without reducing the effect of the cleaning jets from the cleaning tool.

In what follows, an example of a preferred embodiments described, which is visualized in the accompanying drawings, in which:

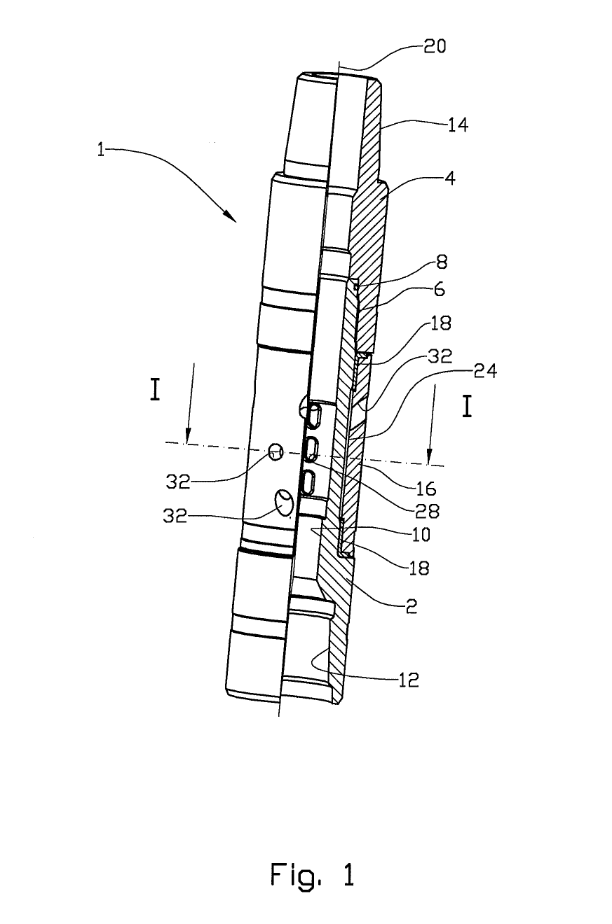

FIG. 1 shows in perspective and in section a cleaning tool in accordance with the invention;

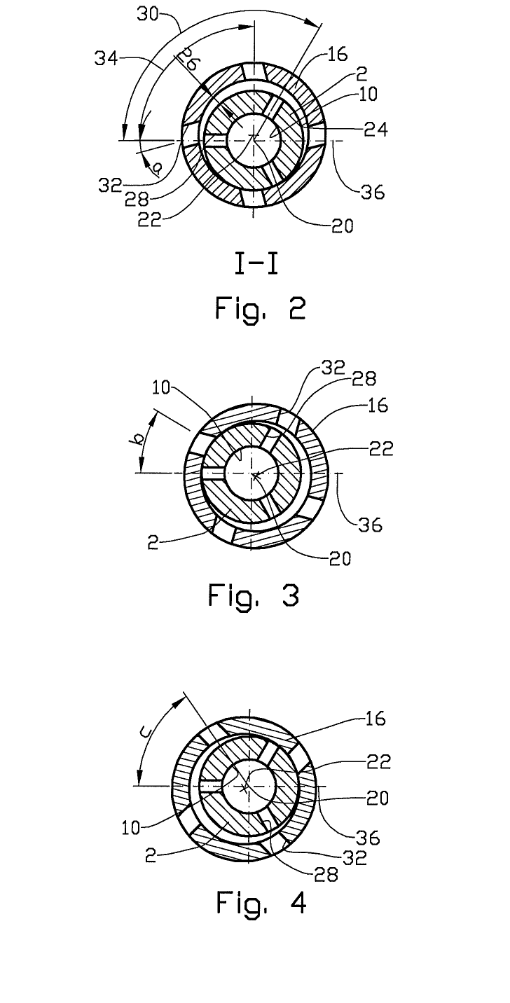

FIG. 2 shows schematically a section I-I of FIG. 1 in which the eccentricity between a stator and a rotor is strongly enlarged;

FIG. 3 shows the same as FIG. 2, but after the rotor has rotated through an angle a; and

FIG. 4 shows the same as FIG. 2, but after the rotor has rotated through an angle b.

In the drawings, the reference numeral 1 indicates a cleaning tool which includes a stator 2 which is connected to an adapter 4 by means of a threaded connection 6 and a seal 8. The stator 2 and the adapter 4 are provided with through-going axial bores 10 and respectively, an internal connection thread 12 and an external connection thread 14 at their free end portions.

A rotor 16 in the form of a cylindrical sleeve surrounds the stator 2 and rotatable around the stator 2 by means of a bearing 18.

The rotor 16 is supported around the centre axis 20 of the stator 2. The centre axis 22 of the rotor 16 thereby rotates around the centre axis 20 of the stator 2. when the rotor 16 rotates around the stator 2, see FIG. 2-4. In FIGS. 2-4, the eccentricity of the rotor 16 is strongly exaggerated for illustrative reasons.

Between the bearings 18, an annular space 24 is arranged. During operation, for reasons of operation that will he explained below, there is differing clearance 26 in the annular space 24, see FIGS. 2-4.

The stator 2 is provided with a number of stator openings 28 which are distributed around the circumference of the stator 2 with a stator sector angle 30. The stator openings 28 are arranged to direct liquid from the through-going opening 10 and out to the rotor 16. In the exemplary embodiment shown, the stator openings 28 are elongated and distributed in three rows of three stator openings 28 each around the centre axis 20 of the stator.

The rotor 16 is provided with a number of rotor openings 32 which are distributed around the circumference of the rotor 16 with a rotor sector angle 34. A number of rotor openings 32, here four, are distributed around the centre axis 22 of the rotor 16 in the section I-I as shown in FIG. 2. These rotor openings 32 have been given an angle a relative to a radial centre line 36 for the reaction force from the flowing liquid through the rotor openings 32 to give a torque to the rotor 16.

Other rotor openings 32, see for example in the face of the cut in FIG. 1, may be placed at an angle relative to the centre axis 20.

The rotor openings 32 normally have a nozzle function.

In FIG. 2, one of the rotor openings 32 corresponds with one of the stator openings 28. When liquid under pressure is flowing to the through-going bore 10, the reaction force from liquid flowing out of the through-going bore 10 will contribute to rotating the rotor 16 while, at the same time, the rotor 16 is moved somewhat radially. The clearance 26 seems to be smallest in the area behind the active rotor opening 32 seen in the direction of rotation.

After the rotor 16 has rotated through an angle b, see figure an adjacent rotor opening 32 relative to the active rotor opening 32 in FIG. 2 has been activated, a position in which the clearance 23 is smallest having moved in the direction of rotation.

Correspondingly, FIG. 4 shows that the rotor 16 has rotated through an angle c and an adjacent rotor opening 32 relative to the active rotor opening 32 of FIG. 3 has been activated, a position in which the clearance 26 is smallest again having moved in the direction of rotation.

By the very fact of the rotor openings 32 being continuously activated and deactivated, each rotor opening 32, each time it is activated, covers only a sector of a cleaning object not shown, which has the effect of the cleaning tool 1 giving the liquid a pulsating effect as well.

1. A cleaning tool for use in boreholes and pipes, the cleaning tool comprising a stator and a rotor in the form of a cylinder sleeve surrounding the stator, which is rotatable around the stator, and there being at least one rotor opening arranged in the rotor for liquid flow, wherein a stator sector angle between adjacent stator openings is different from a rotor sector angle between adjacent rotor openings, wherein during operation, the rotor is radially displaced and rotates eccentrically relative to the stator.

2. The cleaning tool in accordance with claim 1, wherein the stator and the rotor have different numbers of respectively, stator openings and rotor openings or axial sets of rotor openings for liquid flow distributed around their circumferences.

3. The cleaning tool in accordance with claim 1, wherein an adjacent rotor opening relative to the active rotor opening is activated first.

4. The cleaning tool in accordance with claim 1, wherein in each rotational position, the rotor openings of the rotor have a radial resultant angle different from zero.

5. The cleaning tool in accordance with claim 1, wherein the rotor has a rotor opening which is directed at an angle relative to the center axis of the cleaning tool.
